(19) United States
(12) Patent Application Publication
(10) Pub. No.: US 2026/0296178 A1
(43) Pub. Date: Oct. 1, 2026

(54) ATTACHMENT STRUCTURE

(71) Applicant: NISSAN NORTH AMERICA, INC., Franklin, TN (US)

(72) Inventors: Arnold Oswaldo PLATA LOPEZ, Mexico City (MX); David Rodrigo RAMOS CASTILLO, Mexico City (MX); José Eduardo BENITEZ VAZQUEZ, Aguascalientes (MX); Fernando ALCANTARA, Toluca City (MX)

(21) Appl. No.: 19/090,186

(22) Filed: Mar. 25, 2025

(51) Int. Cl. B60K 15/05

(52) U.S. Cl. CPC B60K 15/05

(57) ABSTRACT

An attachment structure for attaching a first panel and a second panel together includes a support, a bracket and a panel retaining clip. The support includes a first end portion and a second end portion. The first end portion is configured to be attached to the first panel. The bracket is configured to be attached to the second end portion of the support. The bracket includes a body having a first opening. The panel retaining clip includes a head portion and a shaft portion. The shaft portion extends through the first opening of the body and a second opening of the second panel where the attachment structure is in an installed state in which the shaft portion is coupled to the second end portion of the support and the second panel is supported by the head portion to secure the second panel to the first panel.

### BACKGROUND

### Technical Field

The present disclosure generally relates to an attachment structure. More specifically, the present disclosure relates to a structure to attach a first panel to a second panel.

### Background Information

Attachment structures are often used to attach two parts. These attachment structures serve many purposes including providing a robust attachment that withstands harsh conditions and providing parts that are easily assembled.

### SUMMARY

Generally, the present disclosure is directed to various features of an attachment structure.

It has been discovered that a new attachment strategy could be used to attach a fuel cover to a fuel tank.

In view of the state of the known technology, one aspect of the present disclosure is to provide an attachment structure for attaching the first panel and the second panel together. The attachment structure fundamentally includes a support, a bracket and a panel retaining clip. The support includes a first end portion and a second end portion. The first end portion is configured to be attached to the first panel. The bracket is configured to be attached to the second end portion of the support. The bracket includes a body having a first opening. The panel retaining clip includes a head portion and a shaft portion. The shaft portion extends through the first opening of the body and a second opening of the second panel where the attachment structure is in an installed state in which the shaft portion is coupled to the second end portion of the support and the second panel is supported by the head portion to secure the second panel to the first panel.

Also, other objects, features, aspects and advantages of the disclosed attachment structure will become apparent to those skilled in the art from the following detailed description, which, taken in conjunction with the annexed drawings, discloses preferred embodiments of the attachment structure.

### BRIEF DESCRIPTION OF THE DRAWINGS

Referring now to the attached drawings which form a part of this original disclosure, illustrative embodiments are shown.

FIG. 1 is a bottom view of a vehicle having a vehicle arrangement including a fuel tank, a protective cover and a plurality of attachment structures in accordance with a first embodiment.

FIG. 2 is a bottom view of the fuel tank and the attachment structures illustrated in FIG. 1 in which a fuel tank cover and a panel retaining clip of each of the attachment structures have been omitted.

FIG. 3 is an enlarged perspective view of a portion of the fuel tank and one of the attachment structures illustrated in FIGS. 1 and 2.

FIG. 4 is an exploded perspective view of the attachment structure illustrated in FIG. 3.

FIG. 5 is an enlarged cross-sectional view of the attachment structure illustrated in FIGS. 3 and 4 as seen along section line 5-5 in FIG. 3.

FIG. 6 is a perspective view of a bracket of the attachment structure illustrated in FIGS. 3 to 5.

FIG. 7 is an elevational view of the bracket illustrated in FIG. 6.

FIG. 8 is a plan view of the bracket of illustrated in FIGS. 6 and 7.

FIG. 9 is a cross-sectional view, similar to FIG. 5, of an attachment structure in accordance with a second embodiment.

FIG. 10 is a perspective view of a bracket of the attachment structure illustrated in FIG. 9.

FIG. 11 is a first perspective view of a support of the attachment structure illustrated in FIG. 9.

FIG. 12 is a second perspective view of the support illustrated in FIG. 11.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

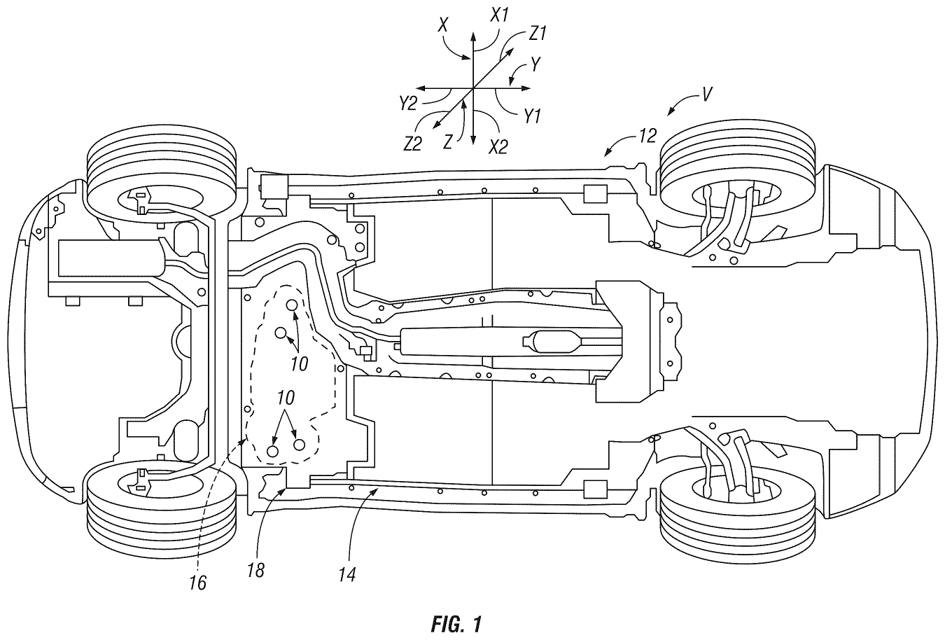

Referring initially to FIG. 1, a bottom of a vehicle V is illustrated in which a plurality of attachment structures 10 are used in accordance with a first embodiment. The vehicle V includes, among other things, a vehicle body structure 12 that includes a floor structure 14, a fuel tank 16 and a fuel tank cover 18. In the first embodiment, a vehicle arrangement fundamentally includes the attachment structures 10, the fuel tank 16 and the fuel tank cover 18. In addition, the vehicle V further includes many conventional vehicle features, structures and components. These conventional vehicle features, structures and components are well known in the vehicle field. Thus, descriptions of these vehicle features, structures and components are omitted for the sake of brevity.

Fundamentally, the vehicle V has a lateral direction X, a lengthwise direction Y and a vertical direction Z (see FIG. 1). The lateral direction X includes a first lateral direction X1 and a second lateral direction X2. The lengthwise direction Y includes a forward direction Y1 and the rearward direction Y2. The vertical direction Z includes an upward direction Z1 and a downward direction Z2.

The fuel tank 16 is attached to the floor structure 14 in a conventional manner such as by one or more mounting straps. For example, in the first embodiment, two mounting straps are used for attaching the fuel tank 16 to the floor panel of the floor structure 14. In such a case, the ends of the mounting straps are attached to the cross members of the floor structure 14, where a middle portion of the mounting straps supports the fuel tank 16 to the floor structure 14. Here, fasteners attach the ends of the mounting straps to the cross members of the floor structure 14.

In the first embodiment, the fuel tank cover 18 is attached to the fuel tank 16 by the attachment structures 10. Thus, each of the attachment structures 10 can be also referred to as a fuel tank cover attachment structure 10. However, one or more of the attachment structures 10 can be used to attach other structures together. For example, the vehicle body structure 14 can include a first panel defining a compartment cavity and a second panel (i.e., a lid) that overlies an opening of the compartment cavity where the second panel (i.e., a lid) is removably attached to the first panel by one or more of the attachment structures 10.

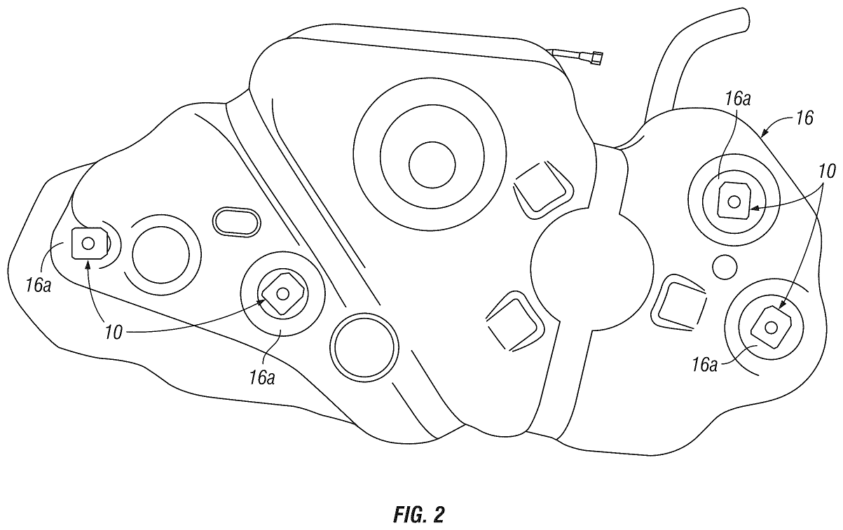

Referring to FIGS. 2-4, in the first embodiment, the fuel tank 16 includes a first panel 16a defining a lower surface of the fuel tank 16. In other words, the first panel 16a is a part of the fuel tank 16. Specifically, the first panel 16a is substantially rigid. Here, in the case of the vehicle V, the first panel 16a includes a plastic or a polymer. For example, here, the fuel tank 16 is made of a high-density polyethylene. However, the first panel 16a can be made of other suitable materials such as a metallic material. The attachment structures 10 are attached to the first panel 16a as discussed below. Since fuel tanks are conventional vehicle structures and components, further description of the fuel tank 16 is omitted for the sake of brevity.

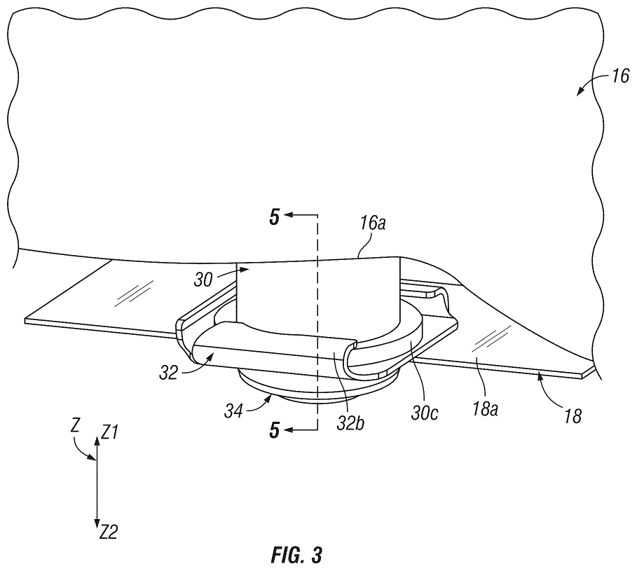

Referring to FIGS. 3-5, the fuel tank cover 18 includes a second panel 18a. In other words, the second panel 18a is a part of the fuel tank cover 18. Thus, the first panel 16a and the second panel 18a are coupled together by the attachment structure 10. The second panel 18a includes at least one second attachment opening AO2 for receiving one of the attachment structures 10. The second attachment opening AO2 has a second diameter D2. At least a portion of the second panel 18a surrounding a perimeter of the at least one attachment opening AO2 defines an attachment plane P1, which can also be referred to as a first attachment plane. In the first embodiment, the second panel 18a includes four of the attachment openings AO2. Thus, four of the attachment structures 10 are used to attach the second panel 18a of the fuel tank cover 18 to the first panel 16a of the fuel tank 16. Each of the portions of the second panel 18 surrounding a perimeter of the attachment openings AO2 defines an attachment plane P1. The attachment planes P1 of the second panel 18 can all lie entirely in a single attachment plane as in the first embodiment. Alternatively, one or more of the attachment planes P1 can be offset from one or more of the attachment planes P1. In any case, each of the attachment planes P1 can also be referred to as a first attachment plane. The second panel 18a is substantially rigid. The second panel 18a includes a plastic or a polymer. Since the fuel tank covers 18 are conventional vehicle structures and components, further description is omitted for the sake of brevity.

Referring to FIGS. 1 and 2, since the attachment structure 10 for one portion of the fuel tank 16 and another attachment structure 10 for another portion of the fuel tank 16 are identical except that they are in different portions of the fuel tank 16, description of the attachment structure 10 applies equally to an additional attachment structure 10. Each of the attachment structures 10 fundamentally includes a support 30, a bracket 32 and a panel retaining clip 34. Here, four of the attachment structures 10 are used for removably coupling the first panel 16a and the second panel 18a together. For example, an additional attachment structure 10 including an additional support 30 attached to the first panel 16a and an additional bracket 32 attached to the additional support 30, and an additional panel retaining clip 34 attached to the additional bracket 32 such that the additional attachment structure 10 supports the second panel 18a to the first panel 16a in a state where the second panel 18a is attached to the first panel 16a. Stated differently, the vehicle arrangement further includes at least one additional attachment structure 10 including an additional support 30 that is the same as the support 30; an additional bracket 32 that is the same as the bracket 32; and an additional panel retaining clip 34 that is the same as the panel retaining clip 34. In the first embodiment, the attachment structures 10 are identical. Thus, only one of the attachment structures 10 will be described hereinbelow for the sake of brevity. Alternatively, the attachment structures 10 can vary in their configuration as needed and/or desired.

Referring to FIGS. 3-5, each of the supports 30 includes a post 30a, a cavity 30b and a flange 30c. The first end portion 30a1 is configured to be attached to the first panel 16a. The second end portion 30a2 is attached to the bracket 32. The support 30 includes a cylindrical portion. The support 30 is a unitary, monolithic part. The support 30 includes a first end portion 30a1 and a second end portion 30a2. Here, the support 30 is rigid. The support 30 includes a plastic or a polymer. Alternatively, while FIG. 3 shows the support 30 includes a cylindrical portion, the support 30 can include at least one of a cuboid portion, hexagonal prism portion, triangular prism portion, etc.

The post 30a includes the first end portion 30a1 and the second end portion 30a2. The first end portion 30a1 includes a first end surface 30a3, and the second end portion 30a2 includes a second end surface 30a4. The first end surface 30a3 is, for example, friction welded to the surface of the first panel 16a of the fuel tank 16. The second end surface 30a4 having a third attachment opening AO3. The third attachment opening AO3 has a third diameter D3. The second end surface 30a4 defines an attachment plane P2, which can also be referred to as a second attachment plane. The first attachment plane P1 is substantially parallel to the second attachment plane P2.

The support 30 includes a cavity 30b extending between the first end portion 30a1 and the second end portion 30a2 of the support. The cavity 30b has a second width W2 that is larger than the third diameter of the third attachment opening AO3.

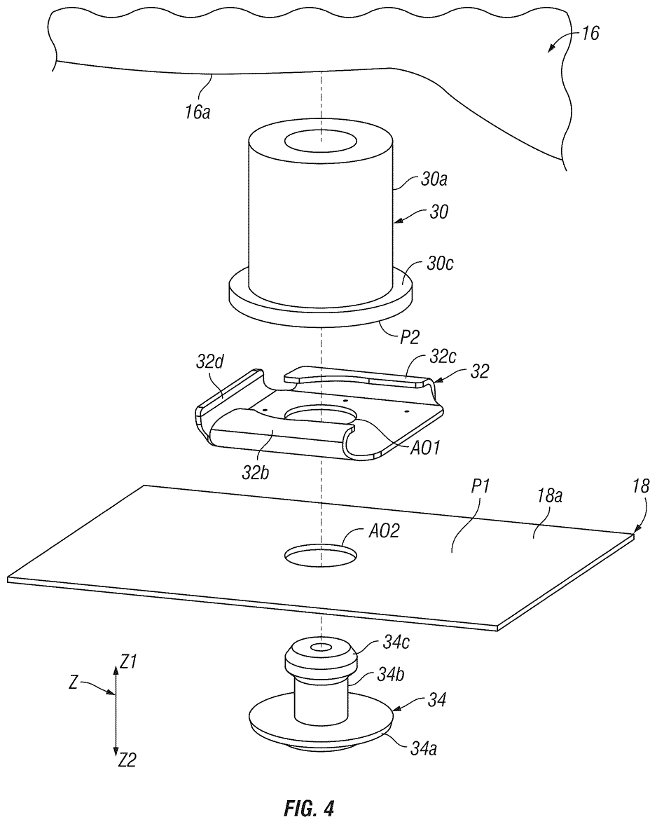

The flange 30c is provided at the second end portion 30a2 of the post 30a. In other words, the second end portion 30a2 of the support 30 includes at least one flange 30c. More specifically, the at least one flange 30c of the support 30 includes an annular flange. Alternatively, while FIG. 4 shows the flange 30c is the annular flange, the flange 30c can be two or more flanges. The flange 30c extends from the post 30a in a direction that is substantially parallel to the second attachment plane P2.

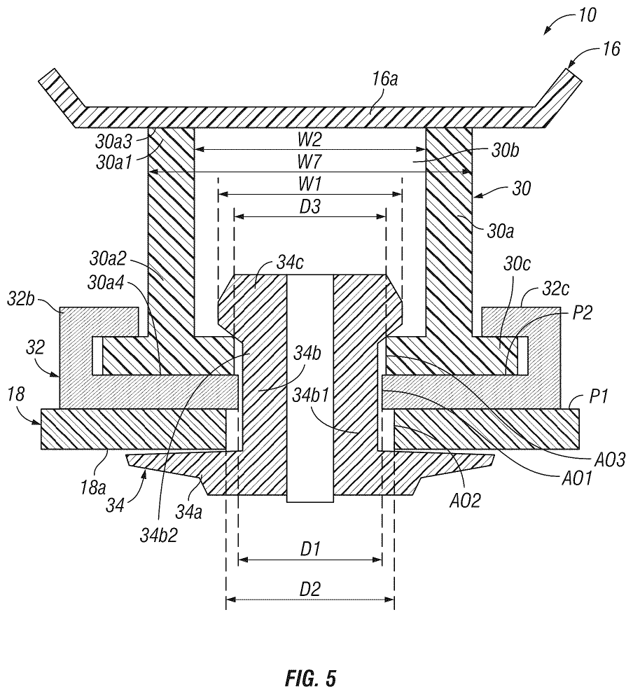

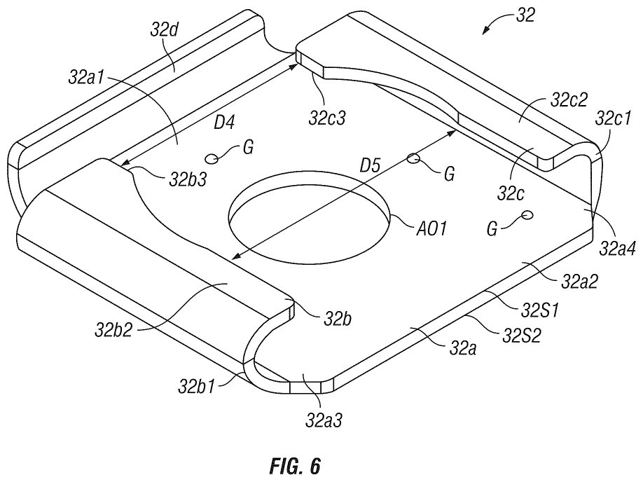

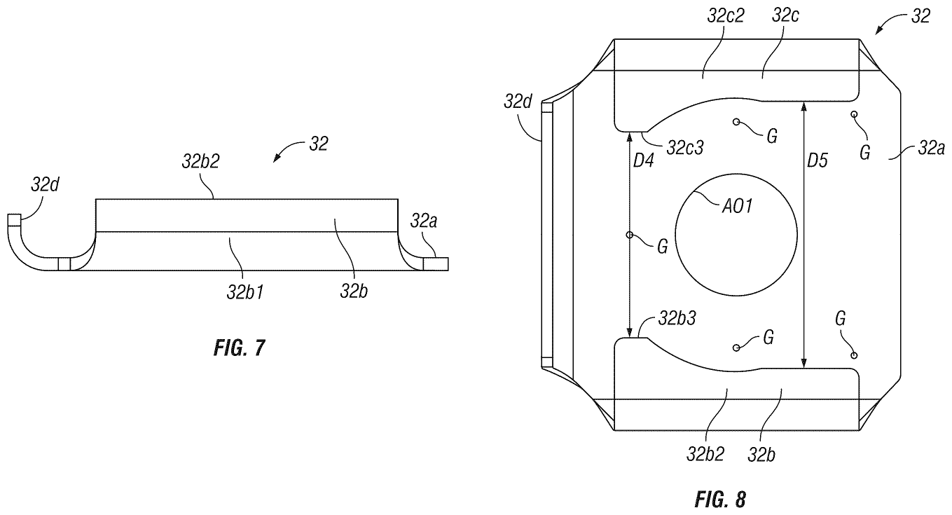

Referring to FIGS. 5 and 6, the bracket 32 includes a body 32a, a first hook 32b, a second hook 32c, a first stopper 32d and gap fillers G. The bracket 32 is configured to be attached to the second end portion 30a2 of the support 30. In this way, the first hook 32b and the second hook 32c couple the bracket 32 to the second end portion 30a2 of the support 30 in the installed state. In other words, the first hook 32b and the second hook 32c are hooked onto the at least one flange 30c to attach the bracket 32 to the second end portion 30a2 of the support 30 in the installed state.

The body 32a includes a first end portion 32a1 and a second end portion 32a2 opposite the first end portion 32a1. The body 32a further includes a first side portion 32a3 and a second side portion 32a4 opposite the first side portion 32a3. The body 32a further includes a first side surface 32S1 and a second side surface 32S2 opposite the first side surface 32S1. The first side surface 32S1 overlays the second end surface 30a4 of the support 30. Here, the body 32a has a first attachment opening AO1. The first attachment opening AO1 has a first diameter D1.

Referring to FIGS. 5 and 6, the first hook 32b is provided to the first side portion 32a3 of the body 32a. Stated differently, the bracket 32 includes the first hook 32b coupled to the body 32a. The first hook 32b includes a first bridging section 32b1 and a first retaining section 32b2. The first retaining section 32b2 extends substantially parallel to the first side surface 32S1 of the body 32a. The first bridging section 32b1 connects the first retaining section 32b2 to the first side portion 32a3 of the body 32a. The first retaining section 32b2 includes a first abutment 32b3. The first abutment 32b3 extends substantially parallel from the first retaining section 32b2.

The second hook 32c is provided to the second side portion 32a4 of the body 32a. Stated differently, the second hook 32c is coupled to the body 32a. The second hook 32c includes a second bridging section 32c1 and a second retaining section 32c2. The second retaining section 32c2 extends substantially parallel to the first side surface 32S1 of the body 32a. The second bridging section 32c1 connects the second retaining section 32c2 to the second side portion 32a4 of the body 32a. The second retaining section 32c2 includes a second abutment 32c3. The second abutment 32c3 extends substantially parallel from the second retaining section 32c2. The first abutment 32b3 and the second abutment 32c3 are spaced apart by an abutment distance D4. The first retaining section 32b2 and the second retaining section 32c2 are spaced apart by a hook distance D5. The width of the post W7 is substantially equal to the hook distance D5 (see FIGS. 5 and 6). The hook distance D5 is greater than the abutment distance D4. Thus, the first abutment 32b3 and the second abutment 32c3 act as stoppers that contact the post 30a of the support 30 to limit movement of the bracket 32 relative to the post 30a of the support 30 during installation of the bracket 32 to the post 30a of the support 30. Alternatively, while FIG. 5 shows the first hook 32b and the second hook 32c couple the bracket to the second end surface 30a4 of the support 30, the bracket 32 can be attached to the second end surface 30a4 of the support 30 by adhesive, fasteners, mortice and tenon, etc.

The gap fillers G extend from the first side surface 32S1 toward the second end surface 30a4 of the support 30. The gap fillers G fill the gap between the first side surface 32S1 of bracket 32 and the second end surface 30a4 of the support 30. The gap fillers G allow a tight fit between the bracket 32 and the second end surface 30a4 of the support 30. Here, the gap fillers G are bumps on the first side surface 32S1. Alternatively, gap fillers G can be ribs, posts, etc. In another alternative, the gap filler G can be coupled to the second end surface 30a4 of the support 30.

Referring to FIG. 6, the stopper 32d is disposed at the first end portion 32a1 of the bracket 32. In other words, the stopper 32d is coupled to the body 32a of the bracket 32. The stopper 32d extends substantially perpendicular to the body 32. The stopper 32d is located between the first hook 32b and the second hook 32c. The bracket 32 includes metal. Preferably, the metal includes steel. More preferably, the steel includes an alloy of iron and carbon. The bracket 32 is a single, monolithic part. The bracket 32 and the support 30 are separate and distinct parts.

Referring to FIG. 5, the panel retaining clip 34 includes a head portion 34a, a shaft portion 34b and a retaining portion 34c. The shaft portion 34b has a first end portion 34b1 and a second end portion 34b2. The head portion 34a is disposed at the first end portion 34b1 of the shaft portion 34b. The retaining portion 34c is disposed at the second end portion 34b2 of the shaft portion 34b. In other words, the retaining portion 34c is provided to the shaft portion 34b. The head portion 34a has a head width W1. The head width W1 is larger than the diameter of the second attachment opening AO2 of the second panel 18a. The head portion 34a supports the second panel 18a. The shaft portion 34b is received by the first attachment opening AO1 of the bracket 32. The retaining portion 34c of the panel retaining clip has a first width W1. The first width is larger than the first attachment diameter D1.

Referring to FIGS. 3-5, in operation, the first hook 32b and the second hook 32c of the bracket 32 slide over the flange 30c of the support 30 such that the first attachment opening AO1 of the bracket 32 is aligned with the third attachment opening AO3 of the support 30. Next, the second panel 18a is placed over the support 30 such that the first attachment opening AO1 of the bracket 32 is aligned with the second attachment opening AO2 of the second panel 18a. Last, the panel retaining clip 34 is inserted sequentially through the second attachment opening AO2 of the second panel 18a, the first attachment opening AO1 of the bracket 32 and the third attachment opening AO3 of the support 30. Thus, the panel retaining clip 34 couples the second panel 18a to the support 30. Stated differently, the shaft portion 34b of the panel retaining clip 34 extends through the first attachment opening AO1 of the body 32a and the second attachment opening AO2 of the second panel 18a where the attachment structure 10 is in an installed state in which the shaft portion 34b is coupled to the second end portion 30a2 of the support 30 and the second panel 18a is supported by the head portion 34a to secure the second panel 18a to the first panel 16a. In other words, the second end portion 30a2 of the support 30 has an end surface 30a4 having the third opening AO3 that receives the shaft portion 34b of the panel retaining clip 34 in the installed state.

### Second Embodiment

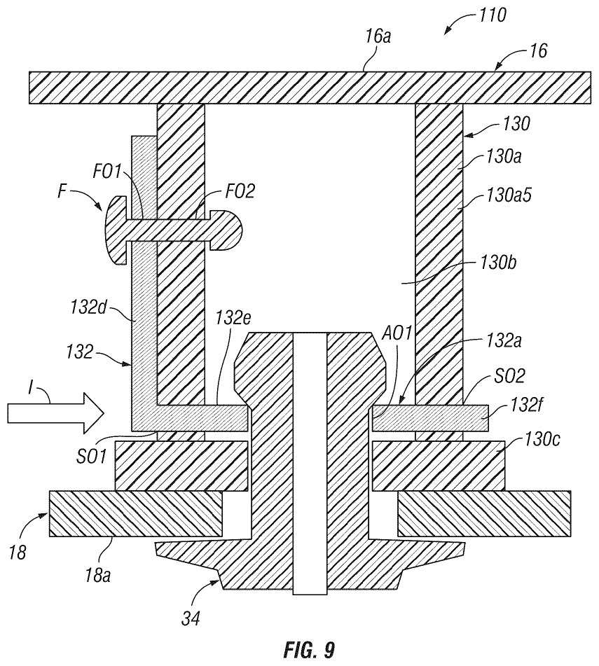

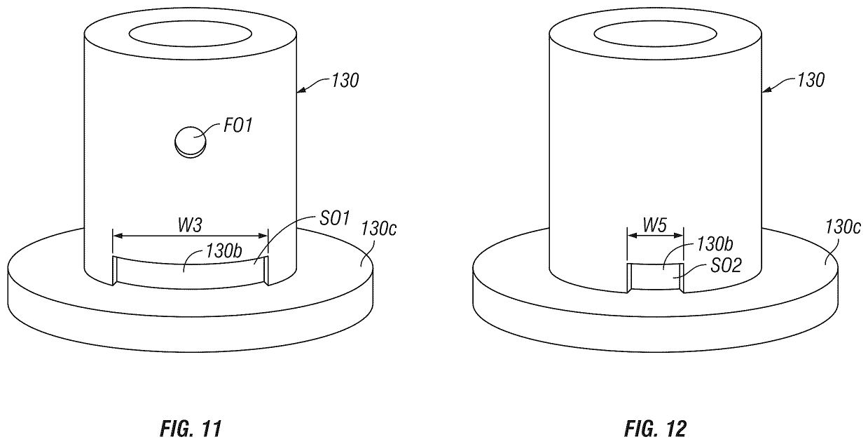

Referring now to FIGS. 9-12, an attachment structure 110 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with 100 series numbers.

Referring to FIG. 9, the attachment structure 110 fundamentally includes a support 130, a bracket 132 and the panel retaining clip 34 of the first embodiment. The support 130 has a post 130a and a flange 130c. The bracket 132 has a body 132a and a fixing part 132d. As mentioned in the first embodiment, the panel retaining clip 34 has the head portion 34a, the shaft portion 34b and the retaining portion 34c. The panel retaining clip 34 is received by the first attachment opening AO1 on the bracket 132 to attach the second panel 18a to the first panel 16a.

Fundamentally, the post 130a of the support 130 has a side wall 130a5 and a cavity 130b. The side wall 130a5 has a first side opening SO1 and a second side opening SO2 opposite the first side opening SO1. More specifically, the first side opening SO1 is a slot and the second side opening SO2 is a slot. The first side opening SO1 of the support 130 has a third width W3. The second side opening SO2 has a fifth width W5. The first side opening SO1 extends entirely through the side wall of the support 130 to the cavity 130b in the installed state. The side wall 130a5 has a second fastener opening FO2. Similar to the first embodiment, the flange 130c of the support 130 is a continuous annular flange that is integrally formed with the post 130a.

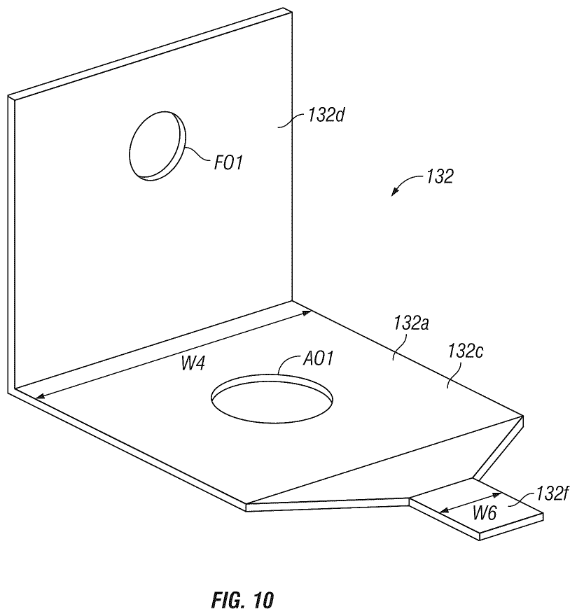

Referring to FIGS. 9 and 10, the bracket 132 includes a first part 132e, a second part 132f and a fixing part 132d. Stated differently, the body 132a includes the first part 132e. The first part 132e of the body 132a has a fourth width. The fourth width W4 is less than the third width W3. The first part 132e includes a first attachment opening AO1. The second part 132f extends substantially parallel to the first part 132e. The second part 132f has a sixth width W6. The fifth width W5 of the second side opening SO2 is greater than the sixth width W6. Here, the first part 132e and the second part 132f lie in a single plane. The fixing part 132d extends substantially perpendicular to the first part 132e of the body 132a. Further, the fixing part 132d extends substantially perpendicularly to the second end surface 130a3 of the support 130. The fixing part 132d includes a first fastener opening FO1.

The fixing part 132d extends transversely from the first part 132e. The fixing part 132d has the first fastener opening FO1.

Referring to FIG. 9, in operation, the bracket 132 is inserted in direction I into the first side opening SO1 of the support 130 and the second side opening SO2 of the support 130. The first side opening SO1 of the side wall 130a5 receives the first part 132e of the body 132a and the second side opening SO2 receives the second part 132f of the body 132a. Stated differently, the first part 132e is received by the first side opening SO1. Next, the fastener F is received in the first fastener opening FO1 and the second fastener opening FO2 to secure the fixing part 132d to the side wall 130a5 in the installed state. Last, similar to the first embodiment, the panel retaining clip 34 is inserted sequentially through the second attachment opening AO2 of the second panel 18a, the first attachment opening AO1 of the bracket 132 and the third attachment opening AO3 of the support 130.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the assembly structure. Accordingly, these terms, as utilized to describe the present invention should be interpreted relative to a vehicle equipped with the assembly structure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the vehicle field from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An attachment structure for attaching a first panel and a second panel together, the attachment structure comprising:
a support including a first end portion and a second end portion, the first end portion being configured to be attached to the first panel;
a bracket configured to be attached to the second end portion of the support, the bracket including a body having a first attachment opening; and
a panel retaining clip including a head portion and a shaft portion, the shaft portion extending through the first attachment opening of the body and a second attachment opening of the second panel where the attachment structure is in an installed state in which the shaft portion is coupled to the second end portion of the support and the second panel is supported by the head portion to secure the second panel to the first panel.

2. The attachment structure according to claim 1, wherein
the bracket includes a first hook coupled to the body and a second hook coupled to the body, the first hook and the second hook coupling the bracket to the second end portion of the support in the installed state.

3. The attachment structure according to claim 2, wherein
the second end portion of the support includes at least one flange, and
the first hook and the second hook are hooked onto the least one flange to attach the bracket to the second end portion of the support in the installed state.

4. The attachment structure according to claim 3, wherein
the least one flange of the support includes an annular flange.

5. The attachment structure according to claim 1, wherein
the second end portion of the support has an end surface having a third attachment opening that receives the shaft portion of the panel retaining clip in the installed state.

6. The attachment structure according to claim 5, wherein
the panel retaining clip further includes a retaining portion, the retaining portion is provided to the shaft portion, the first attachment opening has a first diameter, the second attachment opening has a second diameter, the third attachment opening has a third diameter and the retaining portion of the panel retaining clip has a first width, the first width is larger than the first diameter.

7. The attachment structure according to claim 6, wherein
the support includes a cavity extending between the first end portion and the second end portion of the support, the cavity has a second width that is larger than the third diameter of the third attachment opening.

8. The attachment structure according to claim 2, wherein
the bracket further includes a stopper coupled to the body of the bracket, the stopper is located between the first hook and the second hook.

9. The attachment structure according to claim 1, wherein
the support includes a cylindrical portion.

10. The attachment structure according to claim 1, wherein
the support has a side wall, the side wall has a first side opening, and
the body includes a first part, the first part is received by the first side opening.

11. The attachment structure according to claim 10, wherein
the first side opening is a slot,
the support includes a cavity, and
the first side opening extends entirely through the side wall of the support to the cavity in the installed state.

12. The attachment structure according to claim 10, wherein
the first side opening of the support has a third width, the first part of the body has a fourth width, the fourth width is less than the third width.

13. The attachment structure according to claim 10, wherein
the bracket has a fixing part extending transversely from the body, the fixing part has a first fastener opening, the side wall of the support has a second fastener opening, and
the attachment structure further comprises a fastener is received in the first fastener opening and the second fastener opening to secure the fixing part to the side wall in the installed state.

14. The attachment structure according to claim 1, wherein
the bracket includes metal.

15. The attachment structure according to claim 1, wherein
the support is a unitary, monolithic part.

16. The attachment structure according to claim 1, wherein
the bracket and the support are separate and distinct parts.

17. A vehicle arrangement comprising the attachment structure according to claim 1, and further comprising
the first panel and the second panel coupled together by the attachment structure.

18. The vehicle arrangement according to claim 17, wherein
the first panel is a part of a fuel tank, and
the second panel is a part of a fuel tank cover.

19. The vehicle arrangement according to claim 17, wherein
the first panel includes a plastic or a polymer, the support includes a plastic or a polymer.

20. The vehicle arrangement according to claim 17, further comprises
at least one additional attachment structure including
an additional support that is the same as the support;
an additional bracket that is the same as the bracket; and
an additional panel retaining clip that is the same as the panel retaining clip.
